(19) United States
(12) Patent Application Publication
(10) Pub. No.: US 2008/0103666 A1
(43) Pub. Date: May 1, 2008

(54) Algorithm reliability to improve judgment for roll over of a vehicle

(76) Inventor: Sung Ho Mun, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/646,108

(22) Filed: Dec. 26, 2006

(30) Foreign Application Priority Data
Oct. 31, 2006 (KR) 10-2006-0106824

(51) Int. Cl. G06F 19/00

(52) U.S. Cl. 701/70; 701/45; 280/755; 340/440

(57) ABSTRACT

A first exemplary embodiment of the present invention includes detecting pressures applied to a left front wheel, a left back wheel, a right front wheel, and a right back wheel; and judging that the possibility of roll over exists if any of the pressures applied to the left wheels, the right wheels, or the front wheels is greater than a reference pressure. A second exemplary embodiment of the present invention includes detecting pressures applied to the wheels; and judging that the possibility of roll over exists if a difference in the pressures of the left wheels and the right wheels, or the pressures of the front wheels and the back wheels, is greater than a reference difference. The method may further include controlling the wheels if the possibility of roll over is judged to exist.

### CROSS-REFERENCE TO RELATED APPLICATION

This application claims priority to and benefit of Korean Patent application No. 10-2006-0106824, filed on Oct. 31, 2006, in the Korean Intellectual Property Office, the disclosure of which is incorporated herein by reference.

### BACKGROUND OF THE INVENTION

1. Field of the Invention

The present invention relates to an algorithm for judging roll over of a vehicle, and, more particularly, to an algorithm for judging roll over that detects the pressure on the vehicle's wheels.

2. Description of the Related Art

Typically, to prevent rollover, acceleration of a car is detected by a rolling sensor, a pitching sensor, and a yawing sensor for detecting the accelerations of rolling (rotation around a longitudinal axis), pitching (rotation around a lateral axis), and yawing (rotation around a vertical axis). The state of the car can be judged by a steering angle sensor and a car speed sensor, thereby controlling the wheels.

After detecting roll, pitch, yaw, steering angle, and speed, if it is judged that the car may overturn, the control unit controls the wheels of the car so that the car will not overturn.

Since roll over is controlled without using information related to the tire state, judgment and the control for roll over is not reliable. Further, if all four wheels are controlled together, the car may slide.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides an algorithm for judging roll over by detecting pressure of tires.

A first exemplary embodiment of the present invention includes detecting pressures applied to a left front wheel, a left back wheel, a right front wheel, and a right back wheel; and judging that the possibility of roll over exists if any of the pressures applied to the left wheels, the right wheels, or the front wheels is greater than a reference pressure.

A second exemplary embodiment of the present invention includes detecting pressures applied to a left front wheel, a left back wheel, a right front wheel, and a right back wheel; and judging that the possibility of roll over exists if a difference in the pressures of the left wheels and the right wheels, or the pressures of the front wheels and the back wheels, is greater than a reference difference.

The method may further include controlling the wheels if the possibility of roll over is judged to exist.

### BRIEF DESCRIPTION OF THE DRAWINGS

The above and other features of the present invention will be described with reference to certain exemplary embodiments thereof illustrated the attached drawings in which:

FIG. 1 is a schematic diagram showing parts of a car utilized in an algorithm for judgment of roll over according to an embodiment of the present invention.

FIG. 2 schematically shows a car overturning.

FIG. 3 schematically shows an algorithm for judgment of roll over according to an embodiment of the present invention.

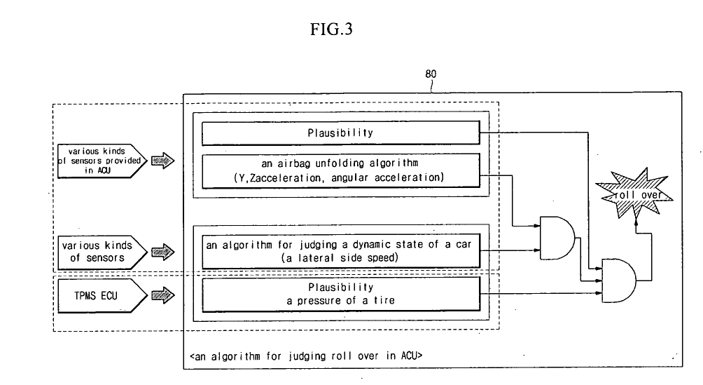

FIG. 4 is a flow chart of an algorithm for judgment of roll over according to an embodiment of the present invention.

FIG. 5 is a flow chart showing in detail a portion of FIG. 4

### DETAILED DESCRIPTION OF THE PREFERRED EMBODIMENTS

Hereinafter, exemplary embodiments of the present invention will now be described in detail with reference to the attached drawings.

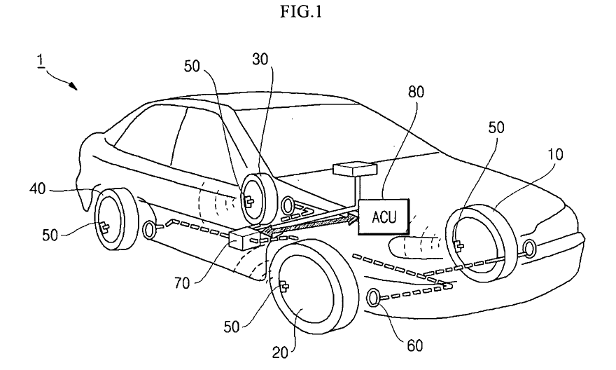

As shown in FIG. 1, an algorithm according to an embodiment of the present invention utilizes an initiator 60 provided in a wheel arch or a fender of the car for identifying the position of a tire, a wheel pressure sensor 50 mounted on each of the wheels 10, 20, 30, 40 for sensing pressure and temperature, a TPMS control unit 70 for controlling the initiator 60, and for transmitting the signals generated from the wheel pressure sensors 50 to an airbag control unit 80, and the airbag control unit 80 for controlling a brake device to cope with the collision of a car.

The wheel pressure sensor 50 measures the pressure applied to the wheels 10, 20, 30, 40 and the temperature of the wheels, and transmits a signal in RF frequency.

The TPMS (Tire Pressure Monitoring System) control unit 70 and airbag control unit 80 may each include a processor, memory, and associated hardware, software, and/or firmware as may be selected and programmed by a person of ordinary skill in the art based on the teachings herein. The TPMS control unit 70 receives the signal from the wheel pressure sensor 50, and transmits the signal to the airbag control unit 80. The TPMS control unit 70 and the airbag control unit 80 can mutually communicate via a CAN (Controller Area Network) communication method (a method in which data can be exchanged via a communication line with connecting each unit in parallel).

An acceleration sensor and an angular acceleration sensor are installed inside or outside the airbag control unit 80, and thus the dynamic state of the car is detected by detecting acceleration along the longitudinal direction of the car body, acceleration along the lateral direction, rolling, pitching, yawing, and a steering angle.

Further, the airbag control unit 80 receives the pressure of the wheels 10, 20, 30, 40 from the TPMS control unit 70 in real time, and judges whether a danger of roll over exists. If it is judged that roll over may be generated, the airbag is prepared, and the brake control device is controlled for controlling each wheel.

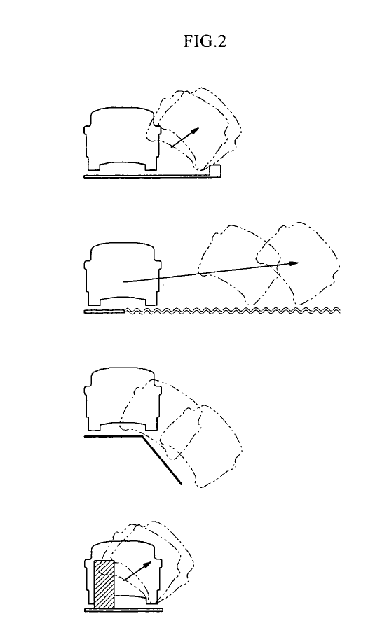

As shown in FIG. 2, a car can overturn in several ways, such as curve trip, in which the car collides into the curb; soil trip, in which surface resistance suddenly increases when there is soil on the shoulder of the road while the car is driving at a very high speed; ditch fall-over, in which the car falls down an inclination; and a lamp or a cork-screw, in which the car collides into the median strip and is overturned while the car is driving at a very high speed. There is also a case in which the car is inclined forward and is overturned (not shown).

When a car is in the process of overturning, since the car I is inclined toward one side, the pressure on the wheels changes without fail. For example, when the car 1 is overturning to the left side, the pressures of the left wheels 10, 30 are greater than those of the right wheels, 20, 40.

If such a pressure difference is detected, the roll over phenomenon can be detected beforehand.

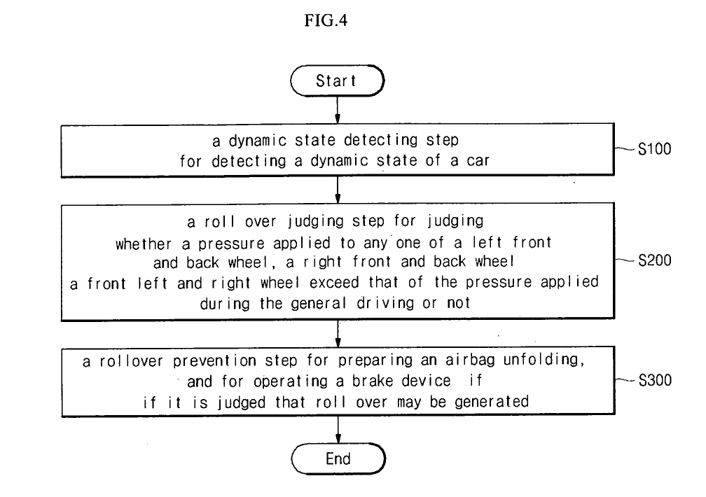

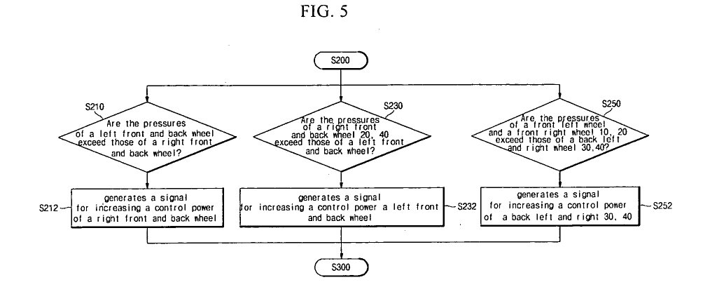

As shown in FIG. 4 and FIG. 5, an algorithm of judgment for roll over according to an embodiment of the present invention includes a dynamic state detecting step S100 for grasping the dynamic state of a car, a roll over judging step S200 for judging whether roll over may occur, and a roll over prevention step S300 for preparing an airbag and a brake control device.

In the dynamic state detecting step S100, the pressures applied to the wheels 10, 20, 30, 40 centering around the longitudinal and lateral directions of the car 1 are detected by the wheel pressure sensors 50.

A dynamic state of the car 1 is ascertained based on the acceleration along the longitudinal and lateral directions, angular speed, steering angle, and car speed related to rolling, pitching and yawing of the car 1 by using an acceleration sensor and an angular speed sensor mounted inside or outside an airbag control unit 80.

It is determined whether the pressure of the wheels 10, 20, 30, 40 is a normal pressure. For this purpose, the pressures applied to the wheels 10, 20, 30, 40 may be measured in advance and set as reference pressures during general driving of the car 1.

In the roll over judging step S200, when the pressures applied to the wheels 10, 20, 30, 40 transmitted via the TPMS control unit 70 is compared with the pre-set pressure information, if the pressure applied to any one of the wheels exceeds the pre-set pressure, it is judged that a roll over phenomenon may be generated.

If a pressure difference between the left wheels 10, 30, and the right wheels 20, 40; or a pressure difference between the front wheels 10, 20, and the back wheels 30, 40 exceeds a difference during general driving, it is judged that a roll over phenomenon may be generated toward the direction to which a larger pressure is applied.

Pressure differences may be determined experimentally and be set as fixed values.

If it is judged that the car I may be overturned, for example, to the left side, the airbag control unit 80 generates a signal for increasing power of the right wheels 20, 40 in order to prevent the roll over phenomenon (S212). Then, an airbag is prepared, and the power of the right wheels 20, 40 is increased by controlling the brake device (S300).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An algorithm for improving reliability of judgment for roll over of a vehicle, comprising,
a dynamic state detecting step for detecting a pressure applied to a left front wheel, a left back wheel, a right front wheel, and a right back wheel centering around a length direction of a car and a width direction of the car, an acceleration of the length direction of the car, and a direction of a car axis, an angular speed related to rolling, pitching and yawing of the car, a steering angle, and a car speed, during a general driving of the car measured by a various kinds of sensors, and then grasping the dynamic state of the car in a TPMS (Tire Pressure Monitoring System) control unit;
a roll over judging step for judging whether the pressure applied to any one of the left front wheel and the left back wheel, the right front wheel and the right back wheel, or the left front wheel and the right front wheel, transmitted via the TPMS control unit in the step of detecting a dynamic state, exceeds that of the general driving by using an airbag control unit; and
a rollover prevention step for allowing the airbag control unit to judge a possibility that a roll over may be generated, to prepare an airbag unfolding, and to control a brake device for controlling each of the wheels independently if the pressure applied to any one of the left front wheel and the left back wheel, the right front wheel and the right back wheel, or the left front wheel and the right front wheel, provided in the roll over judging step, exceed a pre-set pressure;
wherein in the roll over judging step and the rollover prevention step, the TPMS control unit and the airbag control unit are connected mutually via a CAN (Controller Area Network) communication system, and thereby wheel pressure data provided from the TPMS control unit is provided to the airbag control unit in real time.

2. The algorithm for improving reliability of judgment for roll over of a vehicle set forth in claim 1, wherein the roll over judging step further comprises:
a step for judging whether the pressures of the left front wheel and the left back wheel exceed those of the right front wheel and the right back wheel; and
a step for generating a signal for enabling a control power to be increased if the pressures of the left front wheel and the left back wheel exceed those of the right front wheel and the right back wheel, and as a result, judging that the car may be overturned to the left side.

3. The algorithm for improving reliability of judgment for roll over of a vehicle set forth in claim 1, wherein the roll over judging step further comprises:
a step for judging whether the pressures of the right front wheel and the right back wheel exceed those of the left front wheel and the left back wheel; and
a step for generating a signal for enabling a control power to be increased if the pressures of the right front wheel and the right back wheel exceed those of the left front wheel and the left back wheel, and as a result, judging that the car may be overturned to the right side.

4. The algorithm for improving reliability of judgment for roll over of a vehicle set forth in claim 1, wherein the roll over judging step further comprises,
a step for judging whether the pressures of the left front wheel and the right front wheel exceed those of the left back wheel and the right back wheel; and
a step for generating a signal for enabling a control power to be increased if the pressures of the left front wheel and the right front wheel exceed those of the left back wheel and the right back wheel, and as a result, judging that the car may be overturned to the front side.

5. A method of detecting a possibility of roll over of a vehicle, comprising:
detecting pressures applied to a left front wheel, a left back wheel, a right front wheel, and a right back wheel; and
judging that the possibility of roll over exists if any of the pressures applied to the left wheels, the right wheels, or the front wheels is greater than a reference pressure.

6. The method of claim 5, further comprising controlling the wheels if the possibility of roll over is judged to exist.

7. A method of detecting a possibility of roll over of a vehicle, comprising:
detecting pressures applied to a left front wheel, a left back wheel, a right front wheel, and a right back wheel; and
judging that the possibility of roll over exists if a difference in the pressures of the left wheels and the right wheels, or the pressures of the front wheels and the back wheels, is greater than a reference difference.

8. The method of claim 7, further comprising controlling the wheels if the possibility of roll over is judged to exist.
